(19) United States
(12) Patent Application Publication
(10) Pub. No.: US 2025/0386832 A1
(43) Pub. Date: Dec. 25, 2025

(54) APPARATUS AND METHOD FOR SORTING AND ORIENTING FOOD ITEMS

(71) Applicant: MAREL A/S, Aarhus N (DK)

(72) Inventor: Henrik KRISTIANSEN, Aarhus N (DK)

(21) Appl. No.: 18/992,909

(22) PCT Filed: Jul. 6, 2023
(86) PCT No.: PCT/EP2023/068710

§ 371 Date: Jan. 9, 2025

(30) Foreign Application Priority Data
Jul. 15, 2022 (EP) 22185126.4

(51) Int. Cl. A22C 17/00

(52) U.S. Cl. CPC A22C 17/0093; A22C 17/008

(57) ABSTRACT

An apparatus and method for sorting and orienting food items includes a first conveyor, a second conveyor extending from the first conveyor and for transporting, in a second feed direction, food items received from the first conveyor, an opening formed at the end of the first conveyor, a first sensor device for obtaining information on the food items, a pick-and-place robot arranged to pick food items from the first conveyor and place them on the second conveyor, a control module configured for receiving information from the first sensor device and for controlling the robot. The robot is controlled to pick food items from the first conveyor and to place and selectively orient the food item relative to the second feed direction on the second conveyor, if the food item belongs to a first category only, and such that food items belonging to a second category will pass into the opening.

The present invention relates to an apparatus and a method for sorting and orienting food items prior to the processing of the food items in a food item processing device.

The food items may, for example, be vegetables or meat, such as fresh vegetables or meat, and the process in the food item processing device may be packaging of the food items or cutting the food items into portions, or other such processes.

In the following, the invention is exemplified in the context of portion cutting of meat items.

### BACKGROUND OF THE INVENTION

Systems for handling food items, such as meat items are known in the art. For example, WO 2006/061024 A1 describes a system for batching of food items.

Also, automatic portion-cutting machines for cutting meat items according to some predetermined criteria are known in the art.

U.S. Pat. No. 4,557,019 discloses an automatic portion-cutting machine, which measures the shape of a fish fillet, calculates its corresponding volume and weight, and cuts the fillet to create portions of a predetermined size. To this end, fish fillets are advanced along a conveyor to allow these operations to take place. An optical monitoring station along the conveyor sends data relating to the shape of the fillet to a processing unit which calculates the weight of the fillet and actuates a cutting unit to cut the fillet at locations corresponding to the portion size desired.

The incoming meat items, e.g. fillets or other pieces of poultry, in particular chicken, quail, duck, goose, or turkey, are often not uniformly shaped. It thus remains desirable to provide a method and apparatus for portion cutting of meat items that allow the cutting of portions that fulfil predetermined criteria. This also applies to other types of food items.

Also, in connection with processing of the food items in a food item processing device it is desirable to be able to deselect or sort out certain of the food items before entering the food item processing device, for example if the food items do not meet certain standards or could damage the food item processing device. Sorting out food items that are not to be processed in a processing device may provide a uniform flow of usable food items in the processing device and hereby only handle the usable food items.

In particular, it is desirable to provide a method and apparatus for sorting and orienting incoming food items in a quick an efficient manner.

### SUMMARY OF THE INVENTION

In general, at least some embodiments of the method and apparatus disclosed herein seek to mitigate, alleviate or eliminate one or more of the above-mentioned disadvantages and/or other disadvantages of the prior art, or to at least serve as an alternative to prior art solutions.

According to one aspect, disclosed herein are embodiments of an apparatus for for sorting and orienting food items prior to a processing of the food items in a food item processing device, the apparatus comprising
a first conveyor having a first end and a second end, and for transporting food items in a first feed direction;
a second conveyor extending from the second end of the first conveyor, and for transporting in a second feed direction, food items received from the first conveyor to the food item processing device;
an opening formed at the second end of the first conveyor;
at least a first sensor device for obtaining information on the food items on said first conveyor;
a pick-and-place robot arranged to pick individual food items from the first conveyor (310) and place them on the second conveyor; and
a control module configured for
   determining at least the shape of each food item based on the information from said first sensor device,
   categorizing said food items in at least a first category and a second category based on said determination based on the information from said first sensor device and/or a sensor arranged upstream of the first sensor device; and
   controlling said pick-and-place robot to pick categorized food items from the first conveyor, and to place and selectively orient, based on said shape determination, the food item relative to the second feed direction on the second conveyor, if the food item belongs to the first category only, and such that food items belonging to the second category will pass into the opening.

By determining shape of a food item also one or more dimensions, length, width and height of the food item can be determined. Further, based on the shape, the orientation of a food item on the first conveyor may be determined. Determining the orientation of the food item on the first conveyor may be used to control the pick-and-place robot to pick up the food item from the first conveyor and/or to orient the food item, when placing it on the second conveyor.

In an embodiment, said pick-and-place robot is arranged adjacent to said opening. For example, the pick-and-place robot could be arranged directly above the opening. Alternatively, the pick-and-place robot is arranged above the second end of the first conveyor. Alternatively, the pick-and-place robot is arranged above the first end (inlet end) of the second conveyor.

In an embodiment, said opening is a gap between the first conveyor and the second conveyor, the second conveyor being arranged in line with and downstream of the first conveyor.

In an embodiment the second conveyor may form part of the food item processing device.

Preferably, the second conveyor is uninterrupted between a placement location and a cutting location. By placement location is meant the location on the second conveyor, where the food items are placed by the pick-and-place robot, typically an inlet end of the second conveyor.

In a further embodiment, the food item processing device may comprise a knife for portioning food items.

For example, the processing device may be a portion cutter. Portion cutters are known in the art.

In a further embodiment, said categorizing of said food items may be based on said shape determination.

Alternatively or additionally, in further embodiments, the first sensor device and/or any sensors arranged upstream of the first sensor device may be configured to detect one or more quality parameters of the food item, and the categorisation is based on said one or more quality parameters.

In an embodiment thereof, the first sensor device comprises a detection system configured to detect undesirable natural parts of the food items and/or foreign objects.

Undesirable natural parts may for example be blood spots, bruises, cartilage, bone, bone parts, sinews, fat, etc.

Thus, other information than the shape/orientation of the food items may be obtained from either the first sensor device or from one or more sensors arranged upstream of the first sensor device. This information may relate to size, weight, quality (e.g. the quality parameters mentioned above), shape, type derived from form.

In particular, according to one aspect, disclosed herein are embodiments of a method for sorting and orienting food items prior to a processing of the food items in a food item processing device of an apparatus, the apparatus comprising
a first conveyor having a first end and a second end;
a second conveyor extending from the second end of the first conveyor, and for transporting in a second feed direction, food items received from the first conveyor to the food item processing device;
an opening formed at the second end of the first conveyor;
at least a first sensor device for obtaining information on the food items on said first conveyor;
a pick-and-place robot arranged to pick individual food items from the first conveyor and place them on the second conveyor; and
a control module configured for receiving information from at least the first sensor device and for controlling said pick-and-place robot,
   and wherein the method comprises
determining at least the shape of each food item based on the information from said first sensor device,
categorizing said food items in at least a first category and a second category based on the information from said first sensor device and/or a sensor arranged upstream of the first sensor device; and
controlling said pick-and-place robot to pick categorized food items from the first conveyor and to place and selectively orient, based on said shape determination, the food item relative to the second feed direction on the second conveyor, if the food item belongs to the first category only, and such that food items belonging to the second category will pass into the opening.

By determining shape of a food item also one or more dimensions, length, width and height of the food item can be determined. Further, based on the shape, the orientation of a food item on the first conveyor may be determined. Determining the orientation of the food item on the first conveyor may be used to control the pick-and-place robot to orient the food item, when placing it on the second conveyor.

In an embodiment, the second conveyor is arranged in line with and downstream of the first conveyor, and said opening is a gap between the first conveyor and the second conveyor.

In an embodiment, said categorizing of said food items is based on said shape determination.

In a further embodiment thereof, if the detected shape of a food item deviates from a target shape, the food item is categorized in the second category. Alternatively or additionally, in a further embodiment, at least one predetermined dimension of the detected shape is calculated from the shape information, and if the calculated dimension deviates from a set of predetermined threshold values, the food item is categorized in the second category. Thus, if desired, too small or too large food items may be deselected from downstream processing, or directed to alternative processing.

In further embodiments, the first sensor device and or a sensor arranged upstream of the first sensor device may be configured to detect one or more quality parameters of the food item, and the categorisation may be based on said one or more quality parameters.

For example, the first sensor device comprises a detection system configured to detect undesirable natural parts of the food items and/or foreign objects, and the categorization comprises categorizing the food items in the second category if undesirable natural parts and/or foreign objects are detected.

As also mentioned above, undesirable natural parts may for example be blood spots, bruises, cartilage, bone, bone parts, sinews, fat, etc.

Thus, other information than the shape/orientation of the food items may be obtained from either the first sensor device or from one or more sensors arranged upstream of the first sensor device. This information may relate to size, weight, quality (e.g. the quality parameters mentioned above), shape, type.

In a further aspect, any of the embodiments of the method previously mentioned, may be embodiments of a computer-implemented method.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 schematically illustrates an embodiment of an apparatus for sorting and orienting food items prior to a processing of the food items in a food item processing device, as well as illustrating an example of a processing of the food items:

FIGS. 2A-C schematically illustrates the method according to the invention,

FIG. 3A, in a perspective view, illustrate another embodiment of an apparatus for sorting and orienting food items prior to a processing of the food items in a food item processing device, as well as illustrating an example of a processing of the food items;

FIG. 3B, in a top view, shows the apparats of FIG. 3A.

### DETAILED DESCRIPTION OF THE EMBODIMENTS

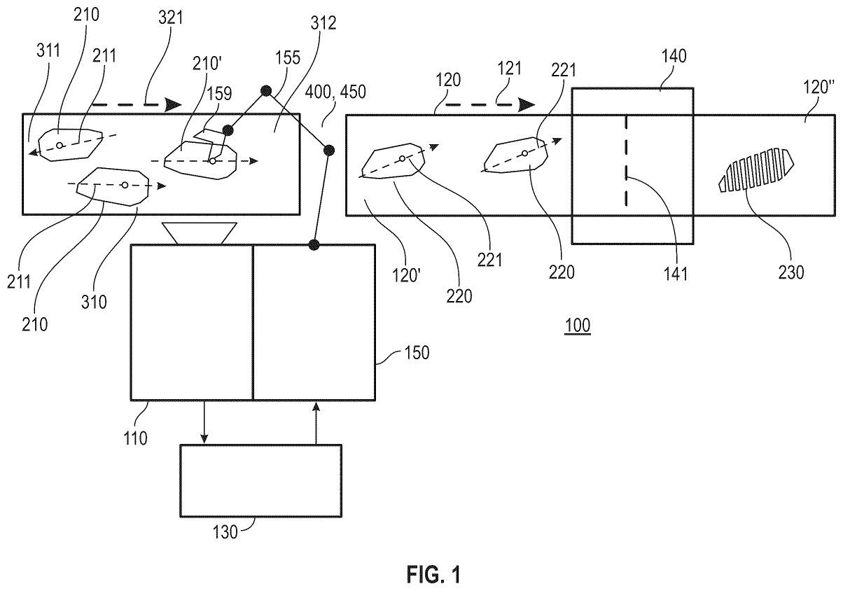

FIG. 1 schematically illustrates an embodiment of an apparatus 100 for sorting and orienting food items 210 prior to a processing of the food items 220 in a food item processing device 140. For example, and as outlined in FIG. 1, the processing in the food item processing device 140 may be portion cutting of meat items, such as breasts of poultry, e.g. chicken. In such embodiments the food item processing device 140 may be a portion cutter. Such portion cutters are known in the art, and will not be described in further detail. It will be appreciated that the food item processing device 140 could be other types of devices, for example a packaging or batching machine, where the orientation of the packed food items may be important.

The apparatus, generally designated by reference numeral 100, comprises a first conveyor 310, a first sensor device 110, a second conveyor 120, a control module 130, a food item processing device 140 and an item positioner, exemplified by a pick-and-place robot 150.

The food item processing device 140, as mentioned, is exemplified by a portion cutter.

The first conveyor 310 has a first end 311 and a second end 312, and is configured for transporting food items 210 in a first feed direction 321, from the first end 311 toward the second end 312 of the first conveyor 310.

The second conveyor 120 has a first end 120′ and a second end 120″, and is configured for transporting food items 220 in a second feed direction 121, from the first end 121′ toward the second end 121″ of the second conveyor 120.

The pick-and-place robot 150 is configured for picking food items 210, 210′ from the first conveyor 310 and placing them on the second conveyor 120. In FIG. 1, food items moving on the first conveyor 310 are designated 210 and 210′, and food items moving on the second conveyor 120 are designated 220.

The second conveyor 120 feeds food items 220 to be processed, for example meat items to be cut into smaller portions, to the food item processing device 140 (portion cutter), as shown in FIG. 1. In particular, the second conveyor 120 feeds the food items 220 to the food item processing device 140 along the second feed direction illustrated by dashed arrow 121.

The food item processing device 140, as exemplified by the portion cutter, processes the food item, for example by cutting the food items 220, in this case meat items into smaller portions 230, e.g. into strips.

To this end, the portion cutter may perform multiple cuts through each meat item 220 to be cut. The portion cutter may perform the cuts in a cutting plane suitably oriented relative to the second feed direction 121, e.g. across the feed direction, such as orthogonal or slightly inclined relative to the feed direction. In FIG. 1, the cutting plane is schematically illustrated by dashed line 141. The portion cutter may be a portion cutter known as such in the art.

The incoming food items 210, 220 may be predetermined cuts of an animal, e.g. breast of poultry such as chicken, fillets etc. or they may be for example fish, either of the same size or species, or varied size and/or species. In some embodiments, the incoming items 210, 220 are boneless meat items, in particular frozen or non-frozen boneless meat items. In yet other embodiments the incoming food items 210, 220 may be vegetables.

Before being fed into the food item processing device 140 such as the portion cutter, shown in FIG. 1, different features are determined of the food items and the food items are selectively oriented relative to the feed direction 121 of the second conveyor 120. To this end, the incoming food items 210 may pass the first sensor device 110, which is utilized for obtaining information of the incoming food items 210 for controlling the pick-and-place robot 150 to at least orient the food items 220 on the second conveyor 120 relative to the second feed direction. The first sensor device 110 may be arranged over the first conveyor 310.

The incoming food items 210 may be received from bulk or from a preceding process, e.g. from another cutting operation.

The incoming food items 210 are conveyed to the first sensor device 110 by the first conveyor 310. The incoming food items 210 may be placed on the first conveyor 310 by a (not shown) placing device. In some embodiments, such a placing device may form part of the apparatus. Preferably, the placing device is of a type, which places the food items 210 individually on the first conveyor 310. By individual placement is meant that the food items are placed one by one, preferably such that the food items do not overlap each other when placed on the first conveyor 310.

The first conveyor 310 and the second conveyor 120 are separated by an opening 400. In the embodiment shown in FIGS. 1-3, the opening is a gap 450 formed between the first conveyor 310 and the second conveyor 120, and the first conveyor 310 and the second conveyor 120 are arranged in line with each other, with the second conveyor 120 downstream of the first conveyor 310, and with the carrier surfaces of the conveyors located in the same general plane. Further, the first feed direction 321 and the second feed direction 121 are illustrated being identical, i.e. they are parallel, and in the same direction.

The first sensor device 110 for obtaining information on the food items 210 on the first conveyor 310 is in electronic communication with the control module 130.

The control module further is in electronic communication with the pick-and-place robot 150.

The pick-and-place robot 150 is arranged to pick individual food items 210 from the first conveyor 310 and place them on the second conveyor 120.

The control module 130 is configured for controlling at least the pick-and-place robot 150 based at least on some of the information received from the first sensor device 110.

The first sensor device 110 may comprise a shape sensor for determining the shape of each of the incoming meat items 210 and forward information in the form of shape data indicative of the measured shapes to the control module 130. The incoming food items 210 may be arbitrarily positioned and/or oriented on the feed conveyor 310. In some embodiments, the incoming food items 210 may be pre-sorted and/or at least partly arranged in a predetermined order, e.g. as a single file or two parallel files, and/or the like.

The first sensor device 110 may use any suitable sensing technology for detecting the shape of the incoming food items 210. In particular, the first sensor device 110 may be an optical sensor, e.g. a laser scanner, a digital camera, etc. or a combination of multiple sensors e.g. a laser scanner and a digital camera. The shape data provided by the first sensor device 110 to the control module 130 may include laser scanning profiles, one or more digital images and other raw sensor data for further processing by the control module 130.

Alternatively or additionally, the shape data provided by the first sensor device 110 to the control module 130 may include processed data. The processing may include one or more initial signal processing steps such as noise reduction, filtering etc. and/or more advanced signal or data processing such as image or signal analysis for object recognition and/or shape analysis. To this end, the first sensor device 110 may perform a processing of the sensor data, e.g. to identify the incoming food items and to create a representation of the measured shape. To this end, the first sensor device 110 may analyze scan lines of a laser scanner, where the scan lines represent respective height profiles of the scanned food item. The first sensor device 110 may thus detect a representation of a contour of the food item 210 being scanned, e.g. a representation comprising a plurality of detected points along the contour of the food item or another suitable representation. In embodiments where the first sensor device 110 includes a digital camera or another image capture device, the first sensor device 110 may perform image analysis to identify the shape of the food item.

It will be appreciated that the first sensor device 110 may output a two-dimensional representation of the shape of the food item, e.g. an image representing a top view and/or a contour of a top view of the item. Alternatively or additionally, the first sensor device may provide a 3D representation of the shape, e.g. by a depth camera, a stereo camera, a laser scanner providing height profiles, etc.

It will further be appreciated that a 2D representation, e.g. a contour of a top view of the food item, may be obtained from such a 3D representation, e.g. by suitable projection.

Alternatively or additionally to determining a representation of a contour of the food item 210, the first sensor device 110 may further output one or more attributes of the food item that are derivable from the detected shape. Examples of such attributes include estimated dimensions, such as length, width, height, volume, and/or derived attributes such as an estimated weight, a center of mass and a reference direction, e.g. an axis of minimum moment of inertia, etc.

In FIG. 1, the center of mass of each food item is schematically illustrated by a dot and a reference direction of each incoming item is illustrated by a dotted arrow 211. In the present example, the reference direction 211 is the axis of minimum moment of inertia. The axis of minimum inertia may be represented as a vector, e.g. a vector pointing away from the center of mass and towards the intersecting point between the axis of minimum moment of inertia and the contour, which is closest to the center of mass. However, it will be appreciated that, in alternative embodiments, a reference direction of a measured shape of an incoming food item may be defined in a different manner, e.g. as a direction of a largest linear extent of the item or otherwise. Examples of shape sensors suitable for detecting a shape of a food item and/or computing derived attributes are known as such in the art.

The shape data may further comprise additional information pertaining to the measured shape, e.g. data indicative of at least one reference direction of the shape, e.g. an axis of minimum moment of inertia and/or an axis of maximum moment of inertia. It will be appreciated that such additional information may be computed and output by the first shape sensor, e.g. using image processing or other data processing techniques known as such in the art. Alternatively, the reference direction of the measured shape may be determined by the control module from the received shape data.

In some embodiments, some or all of the processing of the sensor data (information) for computing the representation of the measured shape and/or of the derived attributes is performed by the control module 130 instead of the first sensor device 110. Yet alternatively, the processing of the sensor data for computing the representation of the measured shape and/or of the derived attributes is partly performed by the first sensor device 110 and partly by the control module 130.

The control module 130 is preferably configured for determining at least the shape of each food item 210 based on the information from said first sensor device 110.

Based on the determination of the shape of a food item 210, the control system is further configured to control the pick-and-place robot 150, to pick a food item from the first conveyor 310 and to place and selectively orient, based on said shape determination, the food item 220 relative to the second feed direction 121 on the second conveyor 120.

For each of the incoming food items 210, the control module 130 may receive shape data (information) from the first sensor device 110 and compute, based on the measured shape and based on one or more predetermined criteria, such as cut criteria, a target orientation associated with the food item 210, the target orientation being indicative of a target angle between the reference direction 211 and the second feed direction 121.

In cases where the mentioned predetermine criteria are cut criteria, the cut criteria may define a target size (or other target criteria) of the cut portions 230 into which the portion cutter cuts the food item, in particular a target length of the strips into which the food item are to be cut.

The control module 130 computes the target orientation of each food item 220 individually, in particular such that the degree of compliance of the cut portions 230, cut from a particular food item, with the target size is maximized. In this respect, the degree of compliance may be quantified as a suitable compliance function to be optimized. In one example, the compliance function may measure the fraction of the food item that results in cut portions fulfilling the target size, e.g. which result in strips having a length within a target range. The control module 130 may thus select the target orientation such that the compliance function is maximized. In other examples, the compliance function may be selected such that the control module may seek to minimize the compliance function. For example, in one embodiment, the compliance function may compute an accumulated degree of deviation of the cut portions 230 from the target size. The degree of deviation may e.g. be measured as the difference of the actual size of the individual cut portions from the target size, optionally weighted by a penalty factor further penalizing undesired deviations. The cut criteria may be determined during manufacture of the apparatus. Alternatively or additionally, the cut criteria may be configurable. To this end, the control module 130 may comprise a memory or other data storage device for storing the cut criteria. The control module may further comprise an interface for receiving cut criteria, e.g. modified cut criteria. The interface may include a communication interface for receiving modified cut criteria from a remote computer and/or a user interface, which may allow a user to manually adjust the cut criteria.

The control module 130 controls the pick-and-place robot 150, which may be positioned downstream of the first sensor device 110, to position the meat items on the cutter feed conveyor 120 at their respective computed target orientations.

The food item positioner is preferably a pick-and-place robot 150, such as a delta robot, which is capable of accurately orienting the individual food items. To this end, the item positioner may comprise an elongated articulate arm 155 and an end actuator 159, for example a claw or other device suitable for picking or gripping the food items 210. The pick-and-place robot 150 may be configured to align the axis of elongation of the end actuator 159 with the actual orientation of the reference direction 211 of each incoming food item, pick the food item, rotate it and place it on the second conveyor 120 with its reference direction 221 directed at the computed target angle relative to the feed direction 121 of the second conveyor 120.

It will be appreciated that in cases where the present invention is used in connection with other downstream processing than the portion cutting illustrated, such as batching or packaging, deboning, etc., similar or other types of criteria may govern the controlling of the orienting the food items 220 on the second conveyor 120.

In the example of FIG. 1, the control module 130 is illustrated as a separate block that is communicatively connected to the first sensor element 110 and to the pick-and-place robot 150. However, it will be appreciated that the control module 130 may be integrated into the first sensor device 110 and/or the pick-and-place robot 150 instead. In one embodiment, the first sensor device 110, the pick-and-place robot 150 and the control module 130 may be implemented as a single machine.

The second conveyor 120 conveys the properly oriented food items 220 to the food item processing device 140, which in FIG. 1 is exemplified with a portion cutter, and in this case the properly oriented food items 220 are cut into portions 230. In order to reduce the risk that the meat items 220 are inadvertently repositioned relative to the feed direction 121 while being conveyed between the item positioner 150 and the food item processing device 140 (portion cutter), it may be preferable that the second conveyor 120 is a straight, uninterrupted conveyor, i.e. where the meat items do not have to travel through sharp turns or be transferred from one conveyor, e.g. from one belt, to another.

In the FIG. 1 example, where the food item processing device 140, is a portion cutter, the portion cutter cuts the meat items 220 along a cutting plane into portions 230 which may then be led to a further processing, such as sorting, batching, packaging and/or the like. The portion cutter typically cuts each food item multiple times so as to obtain cut portions of a desired target size. The multiple cuts may be substantially parallel, e.g. along the same or at least parallel cutting planes 141 relative to the feed direction, thus resulting in cut portions 230 in the form of strips. However, it will be appreciated that, in other embodiments, the portion cutter may perform cuts in a different cut pattern, so as to obtain differently shaped portions. In any event, as the food items 220 are individually oriented relative to the feed direction 121 of the cutter feed conveyor 120, the portion cutter does not need to individually adjust the orientation of the cutting plane 141 or other cut pattern relative to the feed direction 121 of the cutter feed conveyor 120 between consecutive meat items 220 being cut.

In general, the food item processing device 140 may include its own control module (not explicitly shown in FIG. 1) or it may be controlled by control module 130 or by yet another control module.

In either of the above-mentioned embodiments, the control module 130 is further configured for categorizing the food items 210 in at least a first category and a second category based on the information from the first sensor device 110.

The food items 210 belonging to the first category are food items, which are suitable for processing in the food item processing device 140. The food items 210 belonging to the second category are food items, which for whatever reason is not suitable for processing in the food item processing device 140.

Thus, the control module is configured to make the categorization base on a predefined set of criteria.

If the detected food items 210′ belongs to the second category, by the set out criteria, the pick-and-place robot 150 is not instructed to do anything, and the detected food item 210′ will pass into the opening 400, as the first conveyor continue to drive in the first feed direction 321.

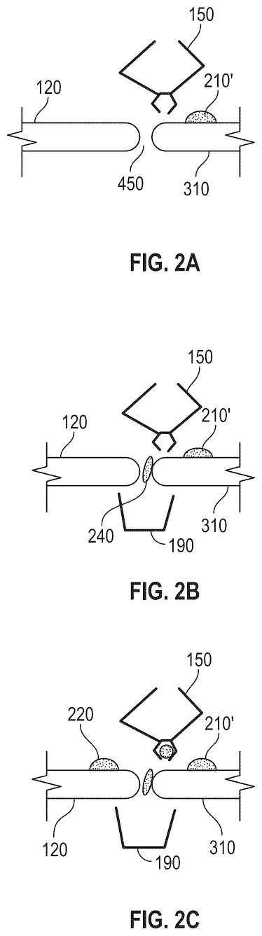

The sorting and orienting function of the apparatus 100 and the method according to the invention is further illustrated in connection with FIGS. 2A-C, showing a first conveyor 310 on the right-hand side of the figures and a second conveyor 120 on the left-hand side, an opening 400 or gap 450 formed there between. The gap 450 is preferably of fixed width configured for a particular type of food items 210.

In FIG. 2A, a food item which has been categorize by the first sensor device 110 as described elsewhere herein, has detected the shape, the size and/or a quality parameter of the food item 210′ entering from the right-hand side of the figure, and moving along the first conveyor 310 towards the left-hand side of the figure. If the categorized food item 210′ has been categorized in the second category, the pick-and-place robot 150 does nothing, and the categorized food item continues over the edge at the second end 312 of the first conveyor 310, enters the gap 450 as a rejected food item 240. The rejected food item 240 may as shown be received in a suitable reject location 190, e.g. a reject bin, a reject conveyor, etc., as illustrated in FIG. 2B. FIG. 2B further shows another categorized food item 210′ entering from the right-hand side of the figure. In FIG. 2C, the pick-and-place robot 150 has picked this second piece of categorized food item 220 and placed and oriented it on the second conveyor 120. Further, as shown in FIG. 2C, the pick-and-place robot 150 has gripped a third categorized food item, and is in the process of moving it towards the second conveyor 120 in order to place an orient it thereon.

In some embodiments, the control module 130 may be configured for controlling the speed of the first conveyor 310, and when a food items 210 approaches the second end 312 of the first conveyer 310, the speed may be increased to accelerate the passing into the opening 400 in order to clear the space on the first conveyor 310.

Thereby food items, which do not meet the predefined criteria, may be sorted away from the stream of food items of the first category, which are to be processed in the food item processing device 140.

The food items belonging to the second category, which are thus deselected/sorted out can be channelled to other processing, used for other purposes e.g. minced meat, or may re-enter the first conveyer 310. The latter situation could occur for example if the food item had been placed in a manner not suitable for being picked by the pick-and-place robot, or if the control module 130 was not able to make an intelligible determination of the category based on the information from the first sensor device 110.

This provides a very efficient and rapid way of sorting only relevant food items and orienting the food items from the first conveyor 310 on the second conveyor 120. Further, this provides a reject mechanism that does not require an active manipulation of the rejected items by the pick-and place robot 150 or otherwise.

It will be appreciated that the control module 130 may cause items to be categorized in the second category, and thereby be passively rejected based on the information on shape (shape data) or other data received from the first sensor device 110. This may be desirable e.g. in case of food items having a shape and/or size outside predetermined specifications.

In one embodiment, the information on shape (shape data) are used to calculate in said control module 130, at least one predetermined dimension of the detected shape, and if the calculated dimension deviates from a set of predetermined threshold values, the food item is categorized in the second category. Thereby, it is made possible to compare the calculated dimension to a threshold or target value, and thereby select or deselect food items 210′ items having a size outside predetermined specifications.

In any of the above-described embodiments, the first sensor device 110 may in addition to the shape information, be configured to detect one or more quality parameters of the food items 210, and the control module 130 be configured to make the mentioned categorisation based on information on said one or more quality parameters.

Such quality parameters may be the presence of foreign objects and/or bones/bone fragments, size, color, spots, marks, blood etc. Such quality parameters may be desirable/acceptable or undesirable/unacceptable. In specific embodiments, the control module may be configured for categorizing food item 210 in the second category and thereby reject/deselect/sort out food items with undesirable natural parts and/or foreign objects in particular when the food items 210 are meat items. Undesirable natural parts in this case may for example be blood spots, bruises, cartilage, bone, bone parts, sinews, fat, etc.

Thus, in any of the above-described embodiments, the first sensor device 110 of the apparatus 100 may further comprise a detection system configured to detect undesirable natural parts of the food items and/or foreign objects.

In any previously described embodiment the first sensor device 110 may comprise a quality sensor that is configured to obtain quality data/information of the incoming food items 210. Such a quality sensor is further an example of a detection system as mentioned above.

In the example of FIG. 1, the quality sensor may be integrated in the illustrated first sensor device 110. Alternatively, it may be a separate entity arranged upstream from the first sensor device 110 at any location of the processing line. Alternatively, the quality sensor may be positioned between the first sensor device 110 and the pick-and-place robot 150.

The quality sensor may use one or more sensors to obtain measurements suitable for assessing the quality of the incoming meat items 210. Examples of quality sensors include an x-ray sensor for detecting foreign objects and/or bones/bone fragments, a color camera or color sensor for detecting discoloring, blood clots, fat content, and/or the like.

The quality sensor may feed the sensed quality data to the control module 130. The control module 130 may thus instruct the pick-and-place robot 150 not to do anything with such food items, which will then be rejected in the opening/gap such that the rejected food items 240 do not reach the food item processing device 140 as exemplified above by the portion cutter. The rejected food items 240 may be collected in a suitable reject location 190.

Preferably, and as shown in FIGS. 1-3, said pick-and-place robot 150 is arranged adjacent to said opening 400 or gap 450. For example, the pick-and-place robot 150 could be arranged directly above the opening. Alternatively, the pick-and-place robot is arranged above the second end 312 of the first conveyor 310. Alternatively, the pick-and-place robot 150 is arranged above the first end 120′ (inlet end) of the second conveyor 120.

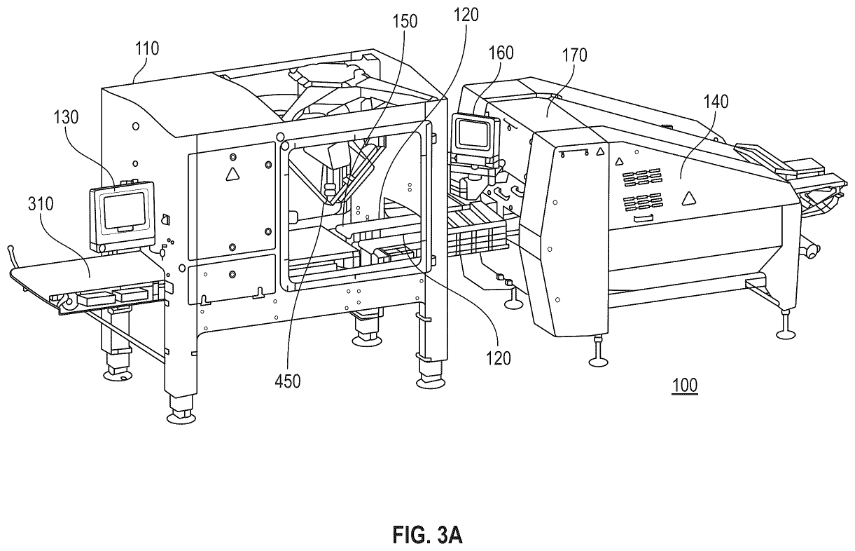

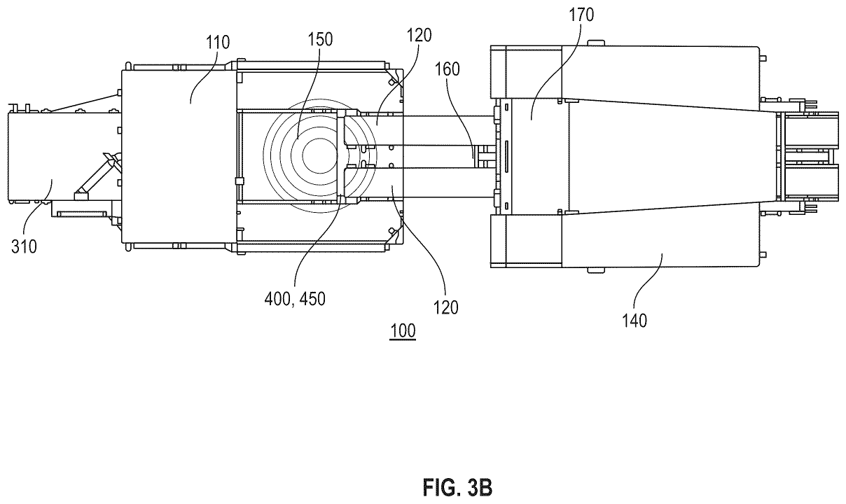

FIGS. 3A-B illustrate yet embodiment of an apparatus 100 for sorting and orienting food items 210 prior to a processing of the food items in a food item processing device 140, where the food item processing device 140 is a portion cutter for portion cutting of the food items, in this case meat items. In particular, FIG. 3A shows a perspective view of the apparatus 100 while FIG. 3B shows a top view of the apparatus 100.

The apparatus 100 of FIGS. 3A-B is largely similar to the embodiment of FIG. 1 in that it comprises a first sensor device 110, a first conveyor 310, a second conveyor 120, a control module 130, a food item processing device 140 in the form of a portion cutter, and an item positioner in the form of a pick-and-place robot 150, all as described above.

In this embodiment, the second conveyor 120 includes two conveyor tracks such that food items/meat items are fed into the portion cutter as two concurrent single files of food items 220, which the portion cutter is configured to process concurrently. To this end, the portion cutter may have two knives that can be controlled individually.

Moreover, in this embodiment, the pick-and-place robot 150 is a delta robot which picks up the incoming items from the first conveyor 310 and places them on the second conveyor 120. The first conveyor 310 and the second conveyor 120 are separate conveyors and they are arranged such that there is a gap 450 between the outlet end/second end 312 of the first conveyor 310, and the first end/inlet end 120′ of the second conveyor 120. The outlet end 312 of the first conveyor 310 and the inlet end 120′ of the second conveyor 120 are both arranged within the working area of the delta robot 150, so as to allow the delta robot 150 to pick up food items from the outlet end 312 of the first conveyor 310 and to place them on the inlet end 120′ of the second conveyor 120. The gap 450 is sized and shaped so as to allow food items/meat items that are not picked up from the first conveyor 310 by the delta robot 150 fall over the outlet end 312 of the first conveyor 310 and through the gap 450. Preferably the gap 450 is sized and shaped such that a food item 210′ reaching the outlet end 312 of the first conveyor 310 cannot reach the inlet end 120′ of the second conveyor 120 and be located on the second conveyor. Food items 210′ not picked up by the pick-and-place robot will enter through the gap 450 between the first conveyor 310 and the second conveyor 120.

Accordingly, an efficient reject mechanism is provided for items that are to be rejected, e.g. if their size and/or shape does not fulfil the requirements, if two items are positioned too close to each other or even on top of each other, or because an upstream quality control sensor has detected them as deviant items. In particular, the delta robot 150 does not need to use capacity on manipulating the food items to be rejected, as they will simply fall through the gap 450. The same goes for items the delta robot 150 does not manage to properly orient, e.g. because too many items reach the delta robot 150 at the same time. These items also fall through the gap 450. Accordingly, all items on the second conveyor 120 are non-rejected items that are properly oriented, thereby reducing the need for sorting the resulting cut portions produced by the portion cutter (as an example of a food item processing device 140).

Embodiments of the method described herein can be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

In particular, in some embodiments, some or all of the components of the apparatus, such as some or all of the shape sensor, the item positioner, the cutter feed conveyor and the portion cutter may be implemented as separate machines operationally connected with each other. In other embodiments, some or all of the above components may be implemented as a partly or completely integrated machine that includes some or all of the above components, e.g. in a single housing or support structure.

It should be emphasized that the term “comprises/comprising” when used in this specification is taken to specify the presence of stated features, elements, steps or components but does not preclude the presence or addition of one or more other features, elements, steps, components or groups thereof. The indefinite article “a” or “an” does not exclude a plurality.

1.-14. (canceled)

15. An apparatus for sorting and orienting food items prior to the processing of the food items in a food item processing device, the apparatus comprising:
a first conveyor having a first end and a second end, and for transporting food items in a first feed direction;
a second conveyor extending from the second end of the first conveyor, and for transporting in a second feed direction, food items received from the first conveyor to the food item processing device;
an opening formed at the second end of the first conveyor;
at least a first sensor device for obtaining information on the food items on said first conveyor;
a pick-and-place robot arranged to pick individual food items from the first conveyor and place them on the second conveyor; and
a control module configured for
determining at least a shape of each food item based on the information from said first sensor device,
categorizing said food items in at least a first category and a second category based on the information from said first sensor device and/or one or more sensors arranged upstream of the first sensor device; and
controlling said pick-and-place robot, to pick categorized food items from the first conveyor and to place and selectively orient, based on said shape determination, the food item relative to the second feed direction on the second conveyor, if the food item belongs to the first category only, and such that food items belonging to the second category will pass into the opening.

16. The apparatus according to claim 15, wherein said opening is a gap between the first conveyor and the second conveyor, the second conveyor being arranged in line with and downstream of the first conveyor.

17. The apparatus according to claim 15, wherein the second conveyor forms part of the food item processing device.

18. The apparatus according to claim 15, wherein the food item processing device comprises a knife for portioning food items.

19. The apparatus according to claim 15, wherein said categorizing of said food items is based on at least said shape determination.

20. The apparatus according to claim 15, wherein the first sensor device and/or a sensor arranged upstream of the first sensor device is configured to detect one or more quality parameters of the food item, and where the categorization is based on said one or more quality parameters.

21. The apparatus according to claim 20, wherein the first sensor device comprises a detection system configured to detect undesirable natural parts of the food items and/or foreign objects.

22. A method for sorting and orienting food items prior to the processing of the food items in a food item processing device of an apparatus, the apparatus comprising:
a first conveyor having a first end and a second end;
a second conveyor extending from the second end of the first conveyor, and for transporting in a second feed direction, food items received from the first conveyor to the food item processing device;
an opening formed at the second end of the first conveyor;
at least a first sensor device for obtaining information on the food items on said first conveyor;
a pick-and-place robot arranged to pick individual food items from the first conveyor and place them on the second conveyor; and
a control module configured for receiving information from at least the first sensor device and for controlling said pick-and-place robot, and
wherein the method comprises:
determining at least a shape of each food item based on the information from said first sensor device,
categorizing said food items in at least a first category and a second category based on the information from said first sensor device and/or or a sensor arranged upstream of the first sensor device; and
controlling said pick-and-place robot to pick categorized food items from the first conveyor and to place and selectively orient, based on said shape determination, the food item relative to the second feed direction on the second conveyor, if the food item belongs to the first category only, and such that food items belonging to the second category will pass into the opening.

23. The method according to claim 22, wherein the second conveyor is arranged in line with and downstream of the first conveyor, and said opening is a gap between the first conveyor and the second conveyor.

24. The method according to claim 22, wherein said categorizing of said food items is based on said shape determination.

25. The method according to claim 24, wherein, if the detected shape of a food item deviates from a target shape, the food item is categorized in the second category.

26. The method according to claim 24, wherein at least one predetermined dimension of the detected shape is calculated from the shape information, and if the calculated dimension deviates from a set of predetermined threshold values, the food item is categorized in the second category.

27. The method according to claim 22, wherein the first sensor device and/or or a sensor arranged upstream of the first sensor device is configured to detect one or more quality parameters of the food item, and where the categorization is based on said one or more quality parameters.

28. The method according to claim 27, wherein the first sensor device comprises a detection system configured to detect undesirable natural parts of the food items and/or foreign objects, and where the categorization comprises categorizing the food items in the second category if undesirable natural parts and/or foreign objects are detected.
